(19) United States
(12) Patent Application Publication
(10) Pub. No.: US 2009/0157987 A1
(43) Pub. Date: Jun. 18, 2009

(54) System and Method for Creating Self-Authenticating Documents Including Unique Content Identifiers

(75) Inventors: David M. Barley, Torrance, CA (US); Ryuji J. Masuda, Santa Rosa Valley, CA (US); Richard Daley, Loveland, CO (US)

Correspondence Address: WHITE & CASE LLP;PATENT DEPARTMENT, 1155 AVENUE OF THE AMERICAS, NEW YORK, NY, 10036, US

(73) Assignee: Casdex, Inc., Camarillo, CA (US)

(21) Appl. No.: 12/330,511

(22) Filed: Dec. 8, 2008

Related U.S. Application Data
(60) Provisional application No. 61/007,632, filed on Dec. 14, 2007.

(51) Int. Cl. G06F 12/00

(52) U.S. Cl. 711/154; 711/E12.002

(57) ABSTRACT

One embodiment of a method for creating a self-authenticating document includes receiving a request to retrieve a data element identified by a content identifier, identifying a storage location associated with the content identifier, retrieving a data element stored at the storage location, calculating a second content identifier of the retrieved data element, comparing the content identifier and the second content identifier, if the content identifier and the second content identifier match, creating an image of the retrieved data element, creating a representation of the stored content identifier, creating a representation of metadata associated with the retrieved data element, and creating a document that includes the image of the retrieved data element, the representation of the stored content identifier, and the representation of metadata. The representation of the stored content identifier may be an alphanumeric string or a graphical representation derived from the stored content identifier.

### CROSS-REFERENCE TO RELATED APPLICATION

This application claims the benefit of U.S. Provisional Application No. 61/007,632 entitled “Affidavit Process for File Authentication Using Unique Content Identifiers,” filed Dec. 14, 2007. The subject matter of the related application is hereby incorporated by reference.

### FIELD OF THE INVENTION

This invention relates generally to content addressable storage and relates more particularly to a system and method for creating self-authenticating documents including unique content identifiers.

### BACKGROUND

Content addressable storage (CAS) is a technique for storing a segment of electronic information that can be retrieved based on its content, not on its storage location. When information is stored in a CAS system, a content identifier is created and linked to the information. The content identifier is then used to retrieve the information. The content identifier is stored with an identifier of where the information is stored. When information is to be stored, a cryptographic algorithm, such as a hashing algorithm, is used to create the content identifier that is ideally unique to the information. The content identifier is then compared to a list of content identifiers for information already stored on the system. If the content identifier is found on the list, the information is not stored a second time. Thus a typical CAS system does not store duplicates of information, providing efficient storage. If the content identifier is not already on the list, the information is stored, and the content identifier is stored in the table with the location of the information.

Content addressable storage is most commonly used to store information that does not change, such as archived emails, financial records, medical records, and publications. Content addressable storage is highly suited to storing information required by compliance programs because the content can be verified as not having changed. Content addressable storage is also highly suited for storing documents that may need to be produced in litigation discovery. A document that can be produced with a content identifier that was created using a reliable hashing algorithm can establish the authenticity of the document. When information is retrieved from a CAS system, a content identifier is provided, and the location corresponding to that content identifier is looked up and the information is retrieved. The content identifier is then recalculated based on the content of the retrieved information and the newly-calculated content identifier is compared to the provided content identifier to verify that the content has not changed.

But all of the verification and authentication done by a typical CAS system occurs in the background. Most CAS systems are behind many network layers and the operation of the CAS system is transparent to the user. A user must take it on faith that the document or other information being retrieved is indeed the information that was originally stored. The problem of verifying that retrieved information is indeed the information that was stored is compounded when the information needs to be provided to another entity, for example in a compliance or a litigation discovery situation. A document retrieved from a CAS system may not have any indicators on its face that would enable one to verify that the retrieved document is identical to the stored content. This may be an issue in situations when it is critical that a printed document match an electronic one. For example, in negotiating contracts and other agreements, drafts are typically exchanged electronically. When finalizing and signing such agreements, it is crucial that the final printed, signed document matches the negotiated final electronic file. In another example, in a litigation where documents to be submitted as evidence need to be authenticated, a person may not be available to testify as to the authenticity of a printout of an electronic file.

### SUMMARY

One embodiment of a method for creating a self-authenticating document includes receiving a request to retrieve a data element identified by a content identifier, identifying a storage location associated with the content identifier, retrieving a data element stored at the storage location, calculating a second content identifier of the retrieved data element, comparing the content identifier and the second content identifier, if the content identifier and the second content identifier match, creating an image of the retrieved data element, creating a representation of the stored content identifier, creating a representation of metadata associated with the retrieved data element, and creating a document that includes the image of the retrieved data element, the representation of the stored content identifier, and the representation of metadata.

One embodiment of a system for creating a self-authenticating document includes a content addressable storage manager configured to control the storing and retrieving of data elements to a content storage, the content addressable storage manager including a content identifier generator configured to produce a content identifier for each data element stored in the content storage, a content addressable storage application coupled to the content addressable storage manager and configured to receive a retrieved data element and a stored content identifier for the retrieved data element from the content addressable storage manager, and configured to create a document that includes an image of the retrieved data element, a representation of the stored content identifier for the retrieved data element, and a representation of metadata of the retrieved data element.

### BRIEF DESCRIPTION OF THE DRAWINGS

FIG. 1 is a block diagram of one embodiment of a system including a content addressable storage system, in accordance with the present invention;

FIG. 2 is a flowchart of method steps for storing a data element into the content addressable storage system of FIG. 1, according to one embodiment of the invention;

FIG. 3 is a flowchart of method steps for creating a self-authenticating document including a data element retrieved from a content addressable storage system, according to one embodiment of the invention;

FIG. 4 is a diagram of one embodiment of a self-authenticating document, in accordance with the invention; and

FIG. 5 is a diagram of another embodiment of a self-authenticating document, in accordance with the invention.

### DETAILED DESCRIPTION

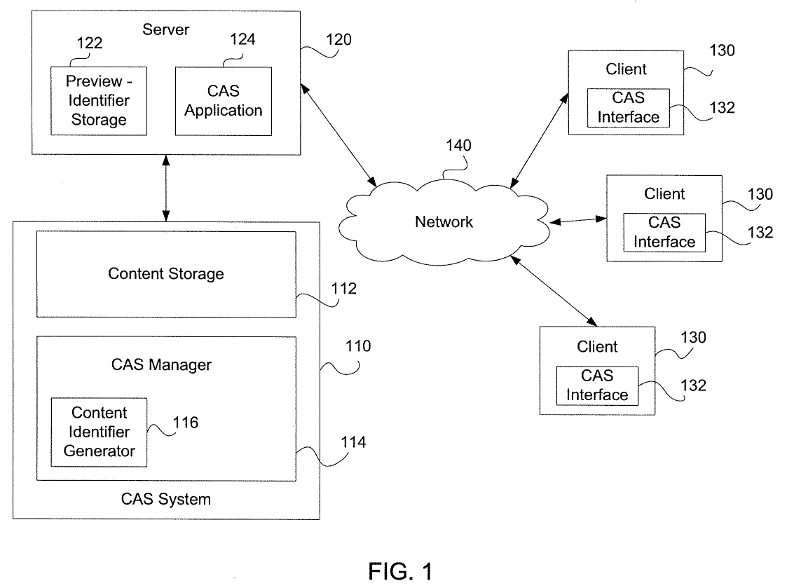

FIG. 1 is a block diagram of one embodiment of a system including, but not limited to, a content addressable storage (CAS) system 110, a server 120, a network 140, and a plurality of clients 130. CAS system 110 includes content storage 112 and a CAS manager 114. Content storage 112 may store data elements of any type, including documents, images, video files, audio files, and emails. Large files may be divided into more than one data element that are stored separately. Content storage 112 is preferably embodied as an array of magnetic disks, but can also be embodied as optical disks, tape, or a combination of magnetic disks, optical disks, and tapes. CAS manager 114 controls the writing of data elements to content storage 112 and controls the reading of data elements from content storage 112. Before writing a data element to content storage 112, CAS manager 114 creates a content identifier for that data element using content identifier generator 116. Content identifier generator 116 applies a hashing algorithm to the content of the data element to generate a unique content identifier for the data element. Content identifier generator 116 also applies the hashing algorithm to metadata associated with the data element to generate a metadata identifier. In one embodiment, the hashing algorithm is the well-known MD5 hash algorithm that produces a 128-bit number derived from the content of a data element; however any other hashing algorithm may be used to generate content identifiers so long as the probability of generating identical content identifiers for different data elements using that hashing algorithm is below an acceptable threshold.

Clients 130 communicate with server 120 via network 140 to store and retrieve content from CAS system 110. Client 130 may be any general computing device such as a personal computer, a workstation, a laptop computer, or a handheld computer. Client 130 includes a CAS interface 132 that is configured to enable a user of client 130 to store content in CAS system 110 and to retrieve content from CAS system 110. CAS interface 132 includes a graphical user interface (GUI) that provides information to a user and enables the user to provide inputs to CAS interface 132. Network 140 may be any type of communication network such as a local area network or a wide area network, and may be wired, wireless, or a combination.

Server 120 includes a CAS application 124 that is configured to communicate with clients 130 and CAS system 110. In one embodiment, CAS application 124 is configured to communicate with clients 130 using a standard communication protocol such as a TCP/IP protocol, and is configured to communicate with CAS system 110 using a storage network protocol such as, for example, Fibre Channel. Server 120 also includes a preview-identifier storage 122 that stores previews of data elements stored in CAS system 110, content identifiers and metadata identifiers associated with the previews, and storage location identifiers associated with the previews. In one embodiment, a preview is a “thumbnail” image of a data element; however other types of previews are within the scope of the invention. In one embodiment, CAS application 124 includes a user interface to enable a user to store and retrieve data elements from CAS system 110.

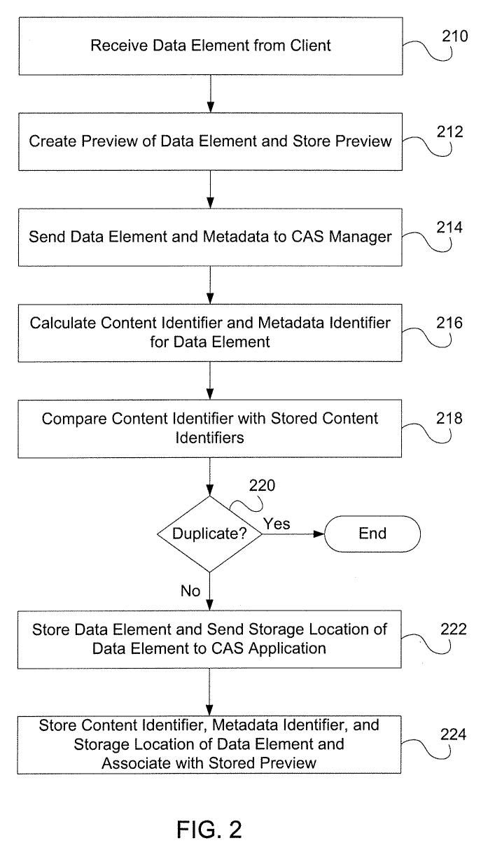

FIG. 2 is a flowchart of method steps for storing a data element into the content addressable storage system of FIG. 1, according to one embodiment of the invention. In step 210, CAS application 124 receives a data element from client 130. A user of client 130 selects a data element and indicates via CAS interface 132 that the data element is to be stored in CAS system 112. In step 212, CAS application 124 creates a preview of the data element and stores the preview in preview-identifier storage 122. In step 214, CAS application 124 sends the data element and metadata associated with the data element to CAS manager 114. The metadata may include a filename, file path, file size, author, and/or date. In step 216, content identifier generator 116 calculates a content identifier for the data element using a hashing algorithm and calculates a metadata identifier for the metadata associated with the data element. In step 218, CAS manager 114 sends the content identifier of the data element and the metadata identifier to CAS application 124, which compares the content identifier with the content identifiers stored in preview-identifier storage 122 to determine if a duplicate of the data element has been previously stored in CAS system 110. In step 220, if the content identifier is not a duplicate, the method continues with step 222, in which CAS manager 114 writes the data element and its metadata to content storage 112 and sends the storage location identifier to CAS application 124. Then in step 224, CAS application 124 stores the content identifier, metadata identifier, and storage location identifier of the data element in preview-identifier storage 112 and associates the content identifier, metadata identifier and storage location identifier with the preview of the data element in preview-identifier storage 112. In one embodiment, preview-identifier storage 112 includes a table that reflects the relationships between a preview of a data element, the content identifier and metadata identifier of that data element, and the storage location of that data element in content storage 112. Returning to step 220, if the content identifier is a duplicate, the method ends because the data element has been previously stored in content storage 112.

The data element to be stored may be a revised version of a data element that has been stored in CAS system 110. For each data element to be stored, CAS application 124 queries preview-identifier storage 122 to determine if a data element with the same filename as the current data element has been previously stored in CAS system 110. If there is only one other data element with that filename stored, CAS application 124 creates an archive that includes the previews, content identifiers, and metadata identifiers of both data elements and will store the previews, content identifiers, and metadata identifiers of all future versions (each a separate data element) for that filename in the archive. If an archive having that filename already exists, CAS application 124 will add the preview, content identifier, and metadata identifier of the data element to the archive.

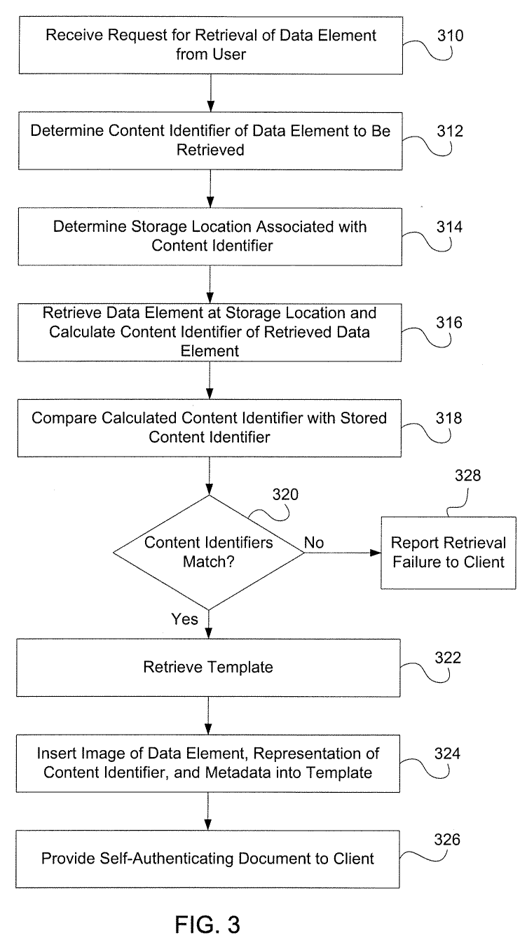

FIG. 3 is a flowchart of method steps for creating a self-authenticating document including a data element retrieved from a content addressable storage system, according to one embodiment of the invention. In step 310, CAS application 124 receives a request from a user for retrieval of a data element via CAS interface 132. In one embodiment, CAS application 124 provides a listing of data elements stored in content storage 112 to CAS interface 132, where the listing identifies the data elements by filename or other metadata. A user then provides input to CAS interface 132 to identify the data element to be retrieved, such as by clicking on a filename displayed by a GUI, and CAS interface 132 sends the selected filename to CAS application 124. In step 312, CAS application 124 determines the content identifier of the data element to be retrieved. In one embodiment, CAS application 124 queries preview-identifier storage 122 for the content identifier that is associated with the filename or other metadata provided by CAS interface 132. In step 314, CAS application 124 determines the storage location associated with the content identifier and provides the storage location to CAS manager 114. In step 316, CAS manager 114 retrieves the data element at the storage location provided by CAS application 124 from content storage 112, calculates the content identifier for the retrieved data element using content identifier generator 116, and sends the retrieved data element and the newly-calculated content identifier to CAS application 124. In step 318, CAS application 124 compares the newly-calculated content identifier with the content identifier stored in preview-identifier storage 122.

In step 320, if the content identifiers match, the method continues with step 322, in which CAS application 124 retrieves a template for a self-authenticating document. The template may be stored in a memory of server 120. In step 324, CAS application 124 converts the data element into a non-alterable image-based format, such as, for example, PDF or TIFF, and inserts the image of the data element into the template. CAS application 124 then inserts a representation of the content identifier of the data element into the template. In one embodiment, the representation of the content identifier is a 26 character alphanumeric string derived from the content identifier; however any representation of the content identifier derived from the content identifier, and the content identifier itself, that is capable of being visually represented to a user is within the scope of the present invention. Examples of content identifier representations that may be used are alphanumeric strings and graphical representations such as one-dimensional or two-dimensional barcodes. CAS application 124 then inserts a representation of the metadata of the retrieved data element into the template. The representation of the metadata may show all of the metadata stored in CAS system 110 or only a portion of the metadata. Once populated with the image of the data element and the representations of the content identifier and the metadata, the template becomes a self-authenticating document. The document is self-authenticating in the sense that it shows that the image of the data element in the document is a true, unaltered copy of the data element that was stored in content storage 112.

Next, in step 326, CAS application 124 provides the self-authenticating document of the data element to CAS interface 132 at the requesting client 130. The self-authenticating document may then be viewed, printed, or copied to a removable media.

Returning to step 320, if the content identifiers do not match, the method continues with step 328, in which CAS application 124 reports the failure to retrieve the requested data element to CAS interface 132 of the requesting client 130.

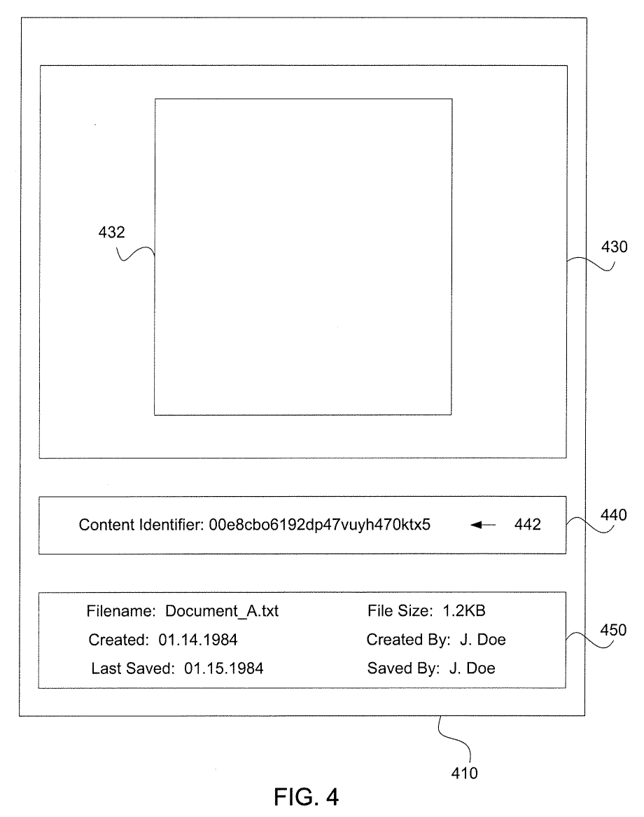

FIG. 4 is a diagram of one embodiment of a self-authenticating document 410, in accordance with the invention. Self-authenticating document 410 is generated by CAS application 124 and includes, but is not limited to, a data image portion 430, an identifier portion 440, and a metadata portion 450. Data image portion 430 contains an image 432 of a data element retrieved from content storage 112. Identifier portion 440 contains a content identifier representation 442 for the data element corresponding to the image 432 in data image portion 430. In the FIG. 4 embodiment, content identifier representation 442 is a 26 character alphanumeric string derived from the content identifier of the data element. Metadata portion 450 contains a representation of metadata of the data element corresponding to the image 432. In the FIG. 4 embodiment, the representation of metadata includes a filename, the date the data element was created, the date the data element was last saved, the file size, the name of the creator of the data element, and the name of the person who last saved the document.

By displaying image 432, content identifier representation 442, and the representation of metadata, self-authenticating document 410 provides confirmation that the content of the data element shown as image 432 is authentic, i.e., that the retrieved data element is exactly the same as the data element that was stored in content storage 112. A printed copy of self-authenticating document 410 provides assurance, because of content identifier representation 442 and the representation of metadata, that the printed document is a true copy of the data element that was stored in content storage 112.

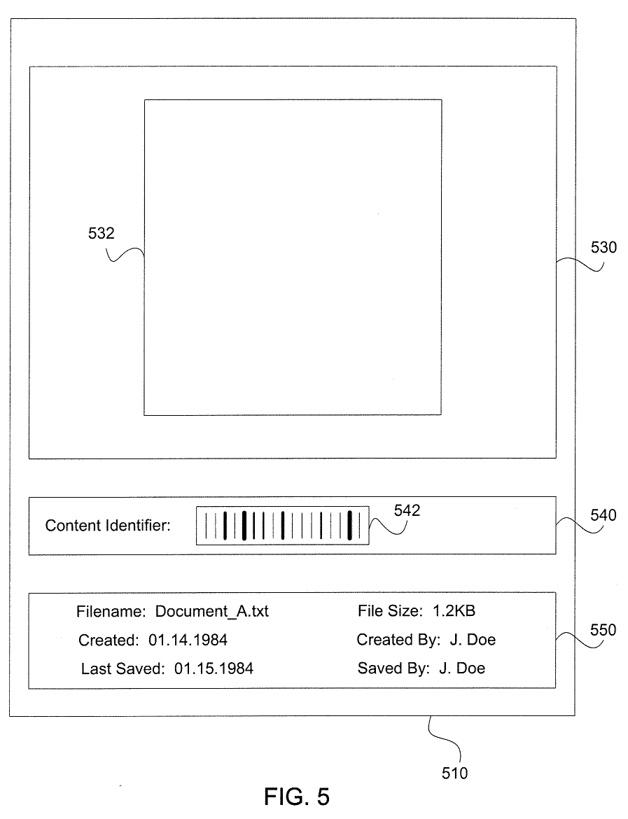

FIG. 5 is a diagram of another embodiment of a self-authentication document 510, in accordance with the invention. Self-authenticating document 510 is generated by CAS application 124 and includes, but is not limited to, a data image portion 530, an identifier portion 540, and a metadata portion 550. Data image portion 530 contains an image 532 of a data element retrieved from content storage 112. Identifier portion 540 displays a content identifier representation 542 for the data element corresponding to image 532 in document image portion 530. In the FIG. 5 embodiment, content identifier representation 542 is bar code derived from the content identifier of the retrieved data element. Metadata portion 550 contains a representation of metadata of the data element corresponding to the image 532. In the FIG. 5 embodiment, the representation of metadata includes a filename, the date the data element was created, the date the data element was last saved, the file size, the name of the creator of the data element, and the name of the person who last saved the document.

By displaying image 532, content identifier representation 542, and the representation of metadata, self-authenticating document 510 provides confirmation that the content of the data element shown as image 532 is authentic, i.e., that the retrieved data element is exactly the same as the data element that was stored in content storage 112. A printed copy of self-authenticating document 510 provides assurance, because of content identifier representation 542 and the representation of metadata, that the printed document is a true copy of the data element that was stored in content storage 112.

While FIGS. 4 and 5 show single-page self-authenticating documents, multiple-page self-authenticating documents are within the scope of the invention. In one embodiment, an identifier portion and a metadata portion are included only on the first-page of a multi-page self-authenticating document. In another embodiment, the identifier portion and metadata portion are repeated on each page of a multi-page self-authenticating document. The arrangement of the data image portion, the identifier portion, and the metadata portion is not limited to the arrangement shown in FIGS. 4 and 5. For example, the identifier portion and the metadata portion may be located in a header or footer area of a self-authenticating document. In another embodiment, a self-authenticating document also includes a digital signature.

The invention has been described above with reference to specific embodiments. It will, however, be evident that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. A method comprising:
receiving a request to retrieve a data element;
determining a stored content identifier of the data element;
identifying a storage location in a storage device, the storage location associated with the stored content identifier;
retrieving a data element stored at the storage location;
calculating a second content identifier of the retrieved data element;
comparing the stored content identifier and the second content identifier; and
if the stored content identifier and the second content identifier match,
creating an image of the retrieved data element,
creating a representation of the stored content identifier,
creating a representation of metadata associated with the retrieved data element, and
creating a document that includes the image of the retrieved data element, the representation of the stored content identifier, and the representation of metadata.

2. The method of claim 1, wherein calculating a second content identifier comprises applying a hashing algorithm to the content of the retrieved data element.

3. The method of claim 2, wherein the stored content identifier was generated using the hashing algorithm.

4. The method of claim 1, wherein the representation of the stored content identifier is an alphanumeric string derived from the stored content identifier.

5. The method of claim 1, wherein the representation of the stored content identifier is a graphical representation derived from the stored content identifier.

6. The method of claim 1, wherein creating a document includes retrieving a template and inserting the image of the retrieved data element, the representation of the stored content identifier, and the representation of metadata into the template.

7. A system comprising:
a content addressable storage manager configured to control the storing and retrieving of data elements to a content storage, the content addressable storage manager including a content identifier generator configured to produce a content identifier for each data element stored in the content storage;
a content addressable storage application coupled to the content addressable storage manager and configured to receive a retrieved data element and a stored content identifier for the retrieved data element from the content addressable storage manager, and configured to create a document that includes an image of the retrieved data element, a representation of the stored content identifier for the retrieved data element, and a representation of metadata of the retrieved data element.

8. The system of claim 7, further comprising a content addressable storage interface configured to communicate with the content addressable storage application and to receive the document from the content addressable storage application.

9. The system of claim 7, wherein the content identifier generator applies a hashing algorithm to the content of a data element to produce a content identifier for the data element.

10. The system of claim 7, wherein the content identifier generator is further configured to calculate a second content identifier for a retrieved data element and the content addressable storage application is further configured to compare the second content identifier with the stored content identifier for the retrieved data element to confirm that the content of the retrieved data element is authentic.

11. The system of claim 10, wherein the content identifier generator is configured to apply a hashing algorithm to the content of the retrieved data element to calculate the second content identifier.

12. The system of claim 7, wherein the representation of the stored content identifier is an alphanumeric string derived from the stored content identifier.

13. The system of claim 7, wherein the representation of the stored content identifier is a graphical representation derived from the stored content identifier.

14. The system of claim 7, wherein the content addressable storage application is configured to create the document by retrieving a template and inserting the image of the retrieved data element, the representation of the stored content identifier for the retrieved data element, and the representation of metadata of the retrieved data element into the template.

15. A computer-readable medium storing instructions for causing a computer to perform:
receiving a request to retrieve a data element;
determining a stored content identifier of the data element;
identifying a storage location in a storage device, the storage location associated with the stored content identifier;
retrieving a data element stored at the storage location;
calculating a second content identifier of the retrieved data element;
comparing the stored content identifier and the second content identifier; and
if the stored content identifier and the second content identifier match,
creating an image of the retrieved data element,
creating a representation of the stored content identifier,
creating a representation of metadata associated with the retrieved data element, and
creating a document that includes the image of the retrieved data element, the representation of the stored content identifier, and the representation of metadata.

16. The computer-readable medium of claim 15, wherein calculating a second content identifier comprises applying a hashing algorithm to the content of the retrieved data element.

17. The computer-readable medium of claim 16, wherein the stored content identifier was generated using the hashing algorithm.

18. The computer-readable medium of claim 15, wherein the representation of the stored content identifier is an alphanumeric string derived from the stored content identifier.

19. The computer-readable medium of claim 15, wherein the representation of the stored content identifier is a graphical representation derived from the stored content identifier.

20. The computer-readable medium of claim 15, wherein creating a document includes retrieving a template and inserting the image of the retrieved data element, the representation of the stored content identifier, and the representation of metadata into the template.
